(19) United States
(12) Patent Application Publication
(10) Pub. No.: US 2008/0083554 A1
(43) Pub. Date: Apr. 10, 2008

(54) HYBRID BONDED FLEX CIRCUIT

(75) Inventors: Robert G. Biskeborn, Hollister, CA (US); George G. Zamora, Vail, AZ (US)

Correspondence Address: CANTOR COLBURN LLP - IBM TUSCON DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/538,637

(22) Filed: Oct. 4, 2006

(51) Int. Cl. H01B 7/08

(52) U.S. Cl. 174/117 F

(57) ABSTRACT

A flexible circuit for bonding to another circuit includes a film having a first conductor layer fabricated upon a topside of the film and a second conductor layer fabricated on an underside of the film, the first conductor layer being insulated by a first insulator layer fabricated thereover, the second conductor layer being insulated by a second insulator layer fabricated thereover; wherein the first conductor layer terminates in at least one bonding pad for the bonding to the another circuit and the second conductor layer terminates in at least one finger lead for the bonding to another circuit. A method for fabricating the flex circuit is provided.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to making electrical connections between flexible circuits and devices.

2. Description of the Related Art

It is known that ultrasonically bonding wires to flexible circuit conductors can be problematic. For example, unreliable connections may occur when the conductors are supported by an adhesively joined insulating layer. In this situation, the conductors tend to deform under the force of an ultrasonic bonding tip. One attempt in the prior art to solve this problem has been to experiment with different adhesives and methods for applications. However, experience has shown that the best epoxies and the thinnest layers are still a compromise.

What are needed are flexible circuit conductors that provide reliable wire bonding connections.

### SUMMARY OF THE INVENTION

The shortcomings of the prior art are overcome and additional advantages are provided through the provision of a flexible circuit for bonding to another circuit, the flexible circuit including: a film having a first conductor layer fabricated upon a topside of the film and a second conductor layer fabricated on an underside of the film, the first conductor layer being insulated by a first insulator layer fabricated thereover, the second conductor layer being insulated by a second insulator layer fabricated thereover; wherein the first conductor layer terminates in at least one bonding pad for the bonding to another circuit and the second conductor layer terminates in at least one flying lead for the bonding to another circuit.

Also disclosed is a method for fabricating a flexible circuit including bonding pads and finger leads, the method including: disposing upon a film a first conductor layer on a topside and a second conductor layer on an underside of the film; disposing upon the first conductor layer a first insulator layer and upon the second conductor layer a second insulator layer; trimming back the first insulator layer to expose the first conductor layer; trimming back the first conductor layer to expose the film and create the bonding pads; removing a portion of the film and the second insulating layer to provide flying leads.

Further disclosed is a tape unit including: a flexible circuit for bonding to a device, the flexible circuit including a film having a first conductor layer fabricated upon a topside of the film and a second conductor layer fabricated on an underside of the film, the first conductor layer being insulated by a first insulator layer fabricated thereover, the second conductor layer being insulated by a second insulator layer fabricated thereover; wherein the first conductor layer terminates in a plurality of bonding pads for bonding to the device and the second conductor layer terminates in a plurality of finger leads for bonding to the device; wherein the plurality of bonding pads are ultrasonically bonded to the bonding wire coupled to the device and the plurality of finger leads are ultrasonically bonded to the device.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a tape data recorder with a device and a flexible circuit;

FIGS. 2A, 2B, 2C, 2D, and 2E, collectively referred to as FIG. 2, illustrate various aspects of a double-sided flexible circuit;

FIG. 3 illustrates a double-sided flexible circuit with an end prepared for making electrical connections;

FIG. 4 illustrates an end view of an embodiment of a flexible circuit used as a cable;

FIG. 5 is a flow chart of an exemplary process for fabricating flying leads and finger leads;

FIG. 6 illustrates flexible circuit connections to a device;

FIG. 7 is a flow chart of the wire bonding process;

FIG. 8 is a cross section of a double-sided flexible circuit;

FIG. 9 is a top view of a double-sided flexible circuit.

The detailed description explains the preferred embodiments of the invention, together with advantages and features, by way of example with reference to the drawings.

### DETAILED DESCRIPTION OF THE INVENTION

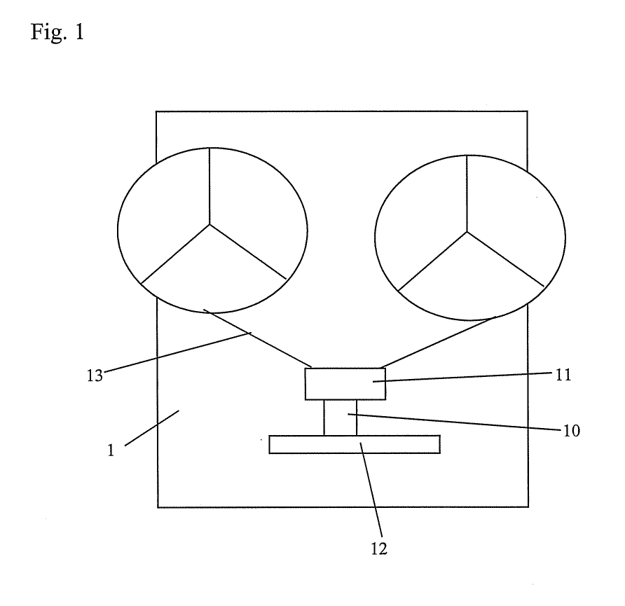

Shown in FIG. 1 is a tape data storage unit 1. The tape data storage unit 1 includes a flexible circuit 10, a device 11, an electronic circuit board 12 and a tape 13. In typical embodiments, the tape 13 provides for data storage. As discussed herein, the flex circuit 10 is an embodiment of a cable. The teachings herein are applicable to flexible circuits 10 and cables fabricated from flexible circuits. In the exemplary embodiment, the flexible circuit 10 electrically connects the device 11 to the electronic circuit board 12. The flexible circuit 10 provides a flexible connection and thus allows the device 11 to articulate when performing its function. Connection to other types of circuits and devices may be realized using the flexible circuit 10 disclosed herein. Use of the flexible circuit 10 as disclosed herein is particularly advantageous for coupling to other circuits having movement relative to another component.

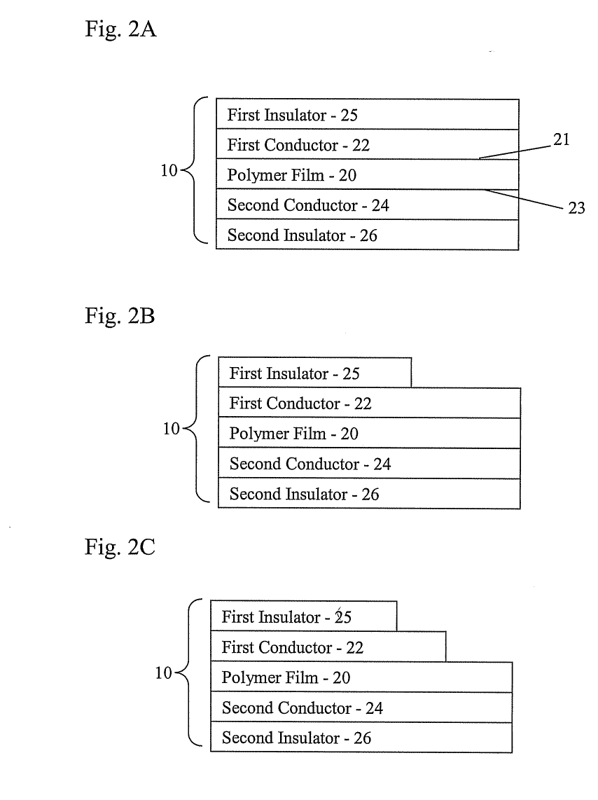

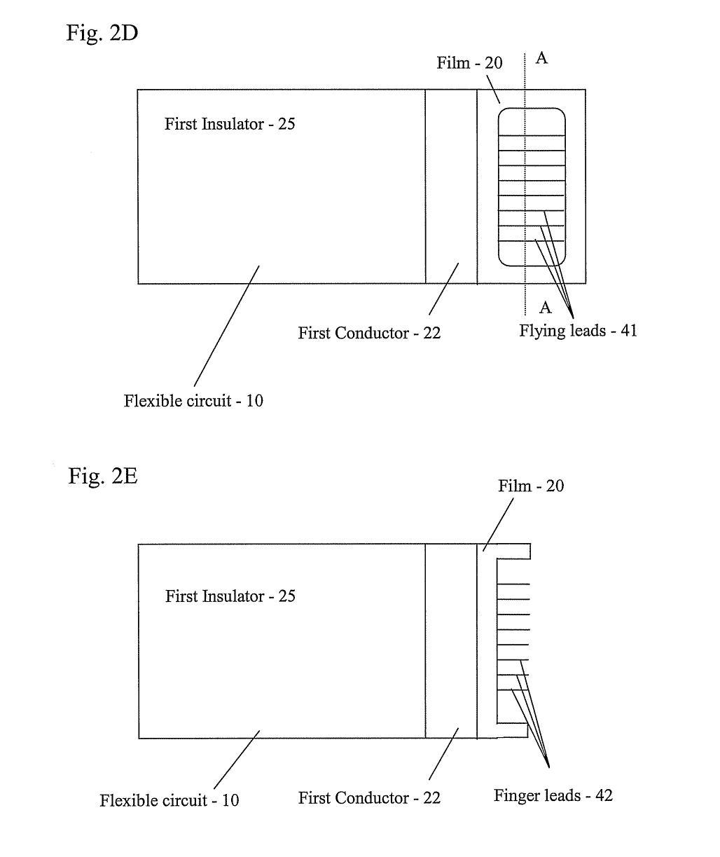

FIGS. 2A thru 2E, collectively known as FIG. 2, illustrate various aspects of preparation of a double-sided flexible circuit. Referring to FIG. 2, the flexible circuit 10 includes a plurality of layers. In this example, the flexible circuit 10 is made up of five layers.

In the embodiment depicted, the flexible circuit 10 includes a topside and an underside. One skilled in the art will recognize that many configurations for flexible circuits and cables fabricated from flexible circuits may be realized. Accordingly, the embodiments discussed herein are merely illustrative and not limiting of the teachings herein.

Referring to FIG. 2A, a flexible film 20 provides a dielectric surface to which a first conductor layer 22 is attached. Typically, the flexible film 20 is a polymer film, however, other flexible dielectric materials may be used. In the embodiment depicted, the first conductor layer 22 is attached to a topside 21 of the film 20. A second conductor layer 24 is attached to an underside 23 of the film 20. As shown herein, the first conductor layer 22 and the second conductor layer 24 include wires as circuit components. However, one skilled in the art will recognize that the conductor layers 22, 24 may also provide other circuitry.

A first insulating layer 25 insulates the first conductor layer 22. Typically, the first insulating layer 25 is adhesively attached to the first conductor layer 22. The first insulating layer 25 may insulate the topside 21 of the film 20 on surface areas not covered by the first conductor layer 22.

Similarly, a second insulating layer 26 insulates the second conductor layer 24. Typically, the second insulating layer 26 is adhesively attached to the second conductor layer 24. The second insulating layer 26 is adhesively attached to the underside 23 of the flexible film layer 20 on surface areas not covered by the second conductor layer 24.

Shown in FIG. 2B is another view of the flexible circuit 10 depicted in FIG. 2A. In FIG. 2B, the first insulator layer 25 is trimmed back exposing the first conductor layer 22. Trimming is merely illustrative of a process to expose a portion of the first conductor layer 22 and not meant to limit the teachings herein. Trimming may include at least one of mechanical trimming, laser trimming, and chemical trimming. Trimming may also include having the flexible circuit manufactured with a portion of the first conductor layer 25 exposed.

Shown in FIG. 2C is a side view of the flexible circuit 10 depicted in FIG. 2B. As depicted, the first conductor layer 22 is trimmed back exposing the film 20. The first conductor layer 22 is trimmed a portion of the way back to an edge of the first insulator layer 25. The first conductor layer 22 extends beyond the first insulator layer 25 by about 0.25 mm. The 0.25 mm dimension is typical and not meant to limit the teachings herein.

Shown in FIG. 2D is a top view of the flexible circuit 10 depicted in FIG. 2C. In FIG. 2C, a portion of the film 20 exposed in FIG. 2C is removed along with a portion of the second insulator layer 26. The portion of the second insulator layer 26 removed corresponds to the portion of the film 20 removed. The result is at least one circuit element of the second conductor layer 24 is exposed. The exposed circuit elements are known as flying leads 41. The flying leads 41 bridge an opening in the polymer film layer 20 and the second insulator layer 26. The flying leads 41 are typically supported on two ends. As discussed herein, the flexible circuit 10 includes a plurality of flying leads 41.

Shown in FIG. 2E is a top view of the flexible circuit 10 depicted in FIG. 2D in which the plurality of flying leads 41 are parted at a generally perpendicular angle (with respect to an orientation of the flying leads 41), such as along line A-A (shown in FIG. 2D). The parting results in the creation of a plurality of finger leads 42. Parting may be performed using any one or more of a variety of techniques for separating portions of electrical circuits. Sections of the film 20 and the second insulator layer 26 are also parted in the vicinity of the flying leads 41.

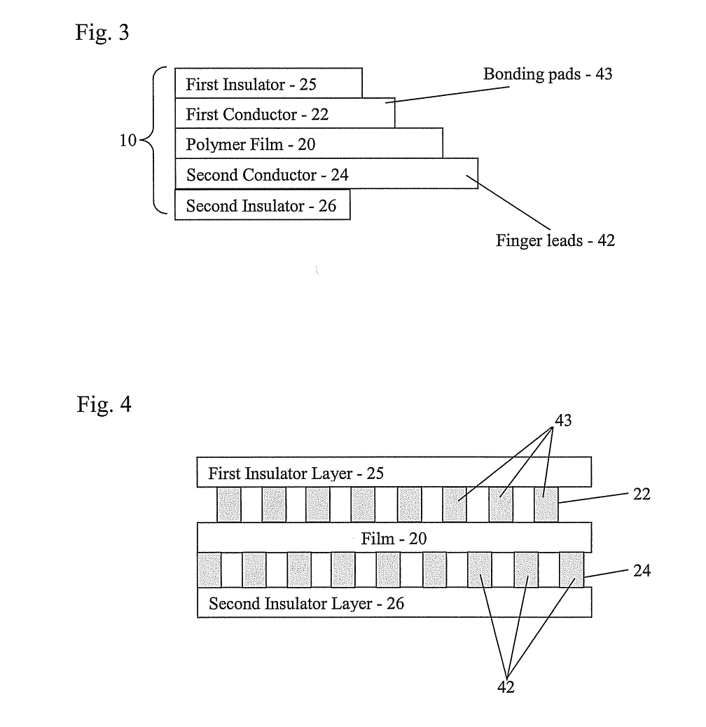

Shown in FIG. 3 is a side view of the flexible circuit 10 depicted in FIG. 2E. Referring to FIG. 3, the first conductor layer 22 extends beyond the first insulator layer 25 and provides a plurality of bonding pads 43. The bonding pads 43 are supported from below by the film 20. The finger leads 42 extend beyond the film 20 and the second insulator layer 26. The finger leads 42 are unsupported from above and below. The second insulator layer 26 is incorporated into the flexible circuit 10 via adhesive. The second insulator 26 and associated adhesive may be trimmed back so as not to be under the bonding pads 43. The elimination of this adhesive for some embodiments of the flexible circuit 10 provides an improvement over the prior art for wire bonding applications.

Shown in FIG. 4 is an end view of the flexible circuit 10 depicted in FIG. 3. As shown in FIG. 4, the bonding pads 43 and the finger leads 42 are staggered. However, this arrangement is merely illustrative and non-limiting.

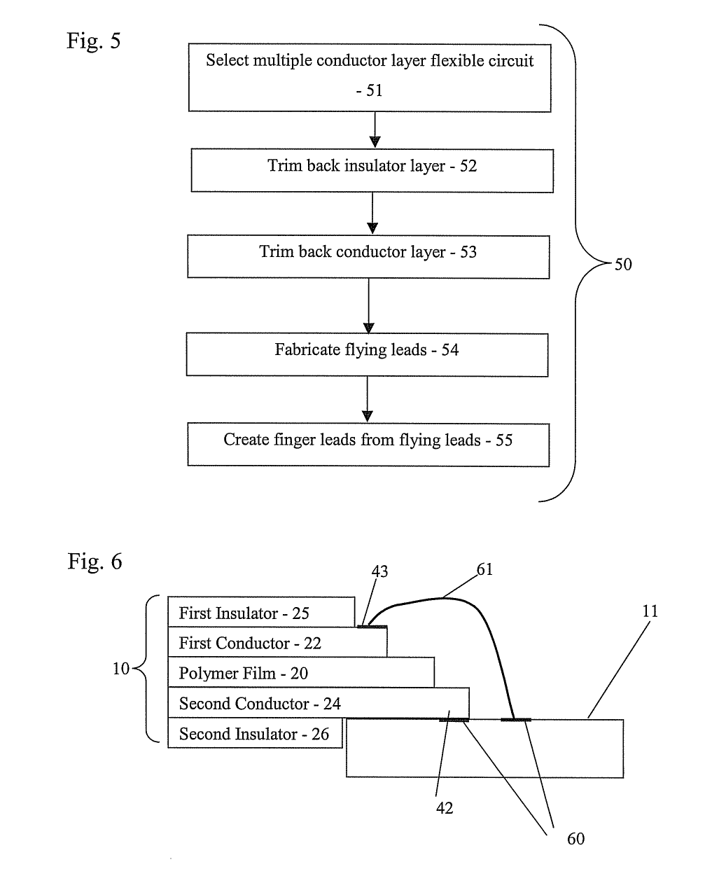

Shown in FIG. 5 is a flow chart depicting aspects of an exemplary method 50 used for preparing the flexible circuit 10 for making external electrical connections. A first step 51 calls for selecting a multiple conductor flexible circuit. In the embodiment discussed, a double-sided flexible circuit is selected as the flexible circuit 10. A second step 52 calls for trimming back the first insulator layer 25 exposing the first conductor layer 22. A third step 53 calls for trimming back the first conductor layer 22 exposing the film 20. The first conductor layer 22 is not trimmed back completely to the first insulator layer 25. The first conductor layer 22 extends beyond the first insulator layer 25 and creates the bonding pads 43. A fourth step 54 calls for fabricating the flying leads 41 by removing a portion of the film 20 and the second insulator layer 26. The removal exposes the second conductor layer 24 from which the flying leads 41 are fabricated. The flying leads 41 are supported on two ends. A fifth step 55 calls for parting the flying leads 41 and thus creating the finger leads 42. Portions of the film 20 and the second insulator layer 26 are also cut in the vicinity of the finger leads 42.

Bonding of the flexible circuit 10 may advantageously male use of multiple techniques. FIG. 6 illustrates a side view of connections of the flexible circuit 10 to the device 11. The device 11 includes a plurality of device bonding pads 60. Also shown is bonding wire 61 used in the stitch bonding process. Referring to FIG. 6, in the embodiment discussed, the plurality of bonding pads 43 are ultrasonically bonded to the corresponding bonding wires 61 coupled to the device 11. One bonding process that may be used is known as stitch bonding. Typically, the film 20, which is supported from below by an external hard surface, provides enough support for an ultrasonic bonding tip to work correctly. In the embodiment discussed, the bonding pads 43 are gold-plated copper and the bonding wire 61 is aluminum.

Bonding the circuitry of the second conductor layer 24 may be accomplished with either the flying leads 41 or the finger leads 42. The flying leads 41 and the finger leads 42 are ultrasonically bonded to the device 11 without any intervening wire. As bonding the finger leads 42 is directly to the device 11, adequate support for the ultrasonic bonding tip to work correctly is realized. One skilled in the art will realize that ultrasonic bonding is merely illustrative. Other bonding processes (for example, thermosonic, thermocompressive and other such techniques) may also be used.

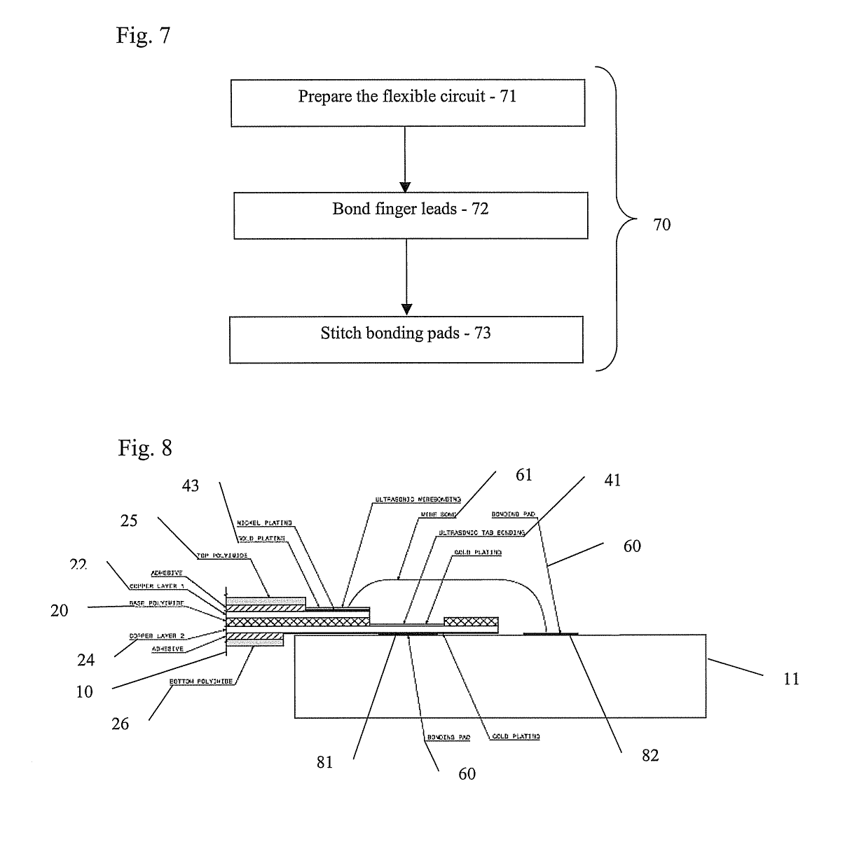

FIG. 7 presents a flow chart depicting an exemplary cable wire bonding process 70. A first step 71 calls for preparing the flexible circuit 10 for bonding, which has been fabricated according to a method 50 such as the one presented in FIG. 5. A second step 72 calls for the finger leads 42 be bonded directly to the device bonding pads 60 without any of the bonding wire 61. A third step 73 calls for the bonding pads 43 to be bonded to the device 11 using the stitch bonding process with the bonding wire 61. The bonding wire 61 used in the process of bonding to the conductor layer 22 bridges over the direct bonds of the finger leads 42 made in Step 72.

FIG. 8 depicts exemplary aspects of a double-sided flexible circuit 10 prepared with flying leads 41 and bonding pads. In the embodiment depicted in FIG. 8, a variety of materials are used. For example, the flexible circuit 10 uses copper for the conductor layers 22 and 24. Gold plating is used on copper in areas where the conductor layers 22 and 24 are not protected by insulator layers 25 and 26, respectively. Nickel plating is applied to the copper in the bonding pads 43 before gold plating is applied. Polyimide is used in the film 20 and insulator layers 25 and 26. As shown in FIG. 8, additional bonding pads 43 (and bonding wires 61 for that matter) may be included. In the embodiment depicted FIG. 8, the plurality of device 11 bonding pads 60 are arranged in two rows, a first row 81 and a second row 82.

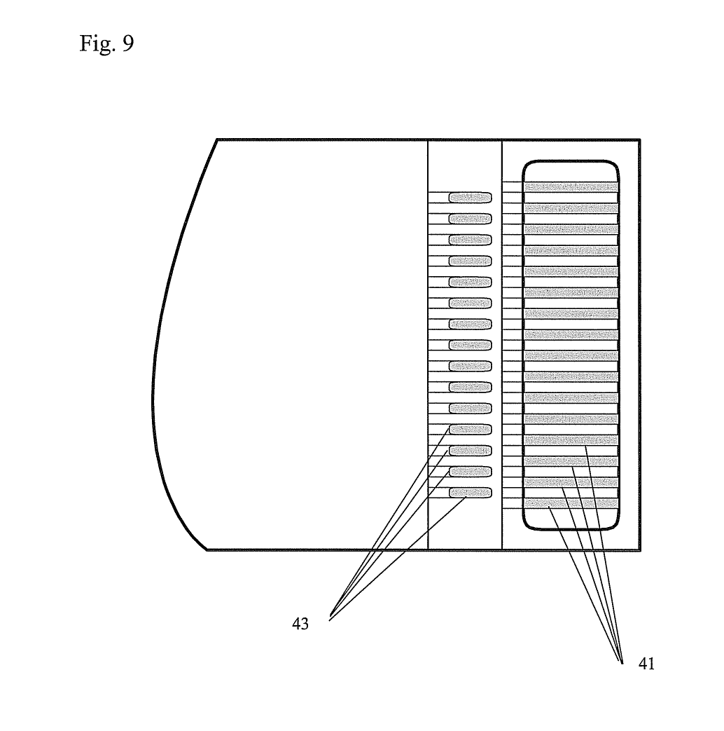

FIG. 9 depicts exemplary aspects of a double-sided flexible circuit 10 prepared with flying leads 41 and bonding pads 43.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A flexible circuit for bonding to another circuit, the flexible circuit comprising:
a film having a first conductor layer fabricated upon a topside of the film and a second conductor layer fabricated on an underside of the film, the first conductor layer being insulated by a first insulator layer fabricated thereover, the second conductor layer being insulated by a second insulator layer fabricated thereover;
wherein the first conductor layer terminates in at least one bonding pad for the bonding to another circuit and the second conductor layer terminates in at least one flying lead for the bonding to another circuit.

2. The flexible circuit as in claim 1, wherein the at least one flying lead is adapted for ultrasonic bonding to another circuit.

3. The flexible circuit as in claim 1, wherein the at least one bonding pad is adapted for bonding to bonding pads on another circuit.

4. The flexible circuit as in claim 1, wherein at least one of the bonding pads and the flying leads comprises at least one of a gold and an aluminum surface for forming an electrical connection thereto.

5. The flexible circuit as in claim 1, wherein the at least one flying lead is modified to provide at least one finger lead.

6. A method for fabricating a flexible circuit comprising bonding pads and flying leads, the method comprising:
disposing upon a film a first conductor layer on a topside and a second conductor layer on an underside of the film;
disposing upon the first conductor layer a first insulator layer and upon the second conductor layer a second insulator layer;
trimming back the first insulator layer to expose the first conductor layer;
trimming back the first conductor to expose the film and create the bonding pads; removing a portion of the film and the second insulating layer to provide flying leads in the second conductor layer.

7. The method as in claim 6, further comprising plating at least one of the bonding pads and the flying leads with at least one of aluminum and gold.

8. The method as in claim 6, further comprising parting the second conductor layer to provide finger leads.

9. The method as in claim 8, further comprising plating at least one of the bonding pads and the finger leads with at least one of aluminum and gold.

10. The method as in claim 6, wherein the removing the portion comprises using a laser to perform the removing.

11. The method as in claim 6, wherein the cutting comprises using a laser to perform the parting.

12. The method as in claim 6, wherein the cutting comprises mechanically cutting.

13. The method as in claim 6, wherein the trimming comprises one of mechanically trimming, laser trimming and chemically trimming.

14. A tape unit comprising:
a flexible circuit for bonding to a device, the flexible circuit comprising a film having a first conductor layer fabricated upon a topside of the film and a second conductor layer fabricated on an underside of the film, the first conductor layer being insulated by a first insulator layer fabricated thereover, the second conductor layer being insulated by a second insulator layer fabricated thereover; wherein the first conductor layer terminates in a plurality of bonding pads for bonding to the device and the second conductor layer terminates in a plurality of finger leads for bonding to the device; wherein the plurality of bonding pads is ultrasonically bonded to bonding wire coupled to the device and the plurality of finger leads are ultrasonically bonded to the device.
